(19) United States
(12) Patent Application Publication
(10) Pub. No.: US 2002/0080447 A1
(43) Pub. Date: Jun. 27, 2002

(54) Transmission system with enhanced repeaters

(76) Inventors: Julian Fells, Epping (GB); Garry Adams, Great Dunmow (GB); Ian Hardcastle, Harlow (GB); Robert Spagnoletti, Hertford (GB); Alan Robinson, Harlow (GB)

Correspondence Address: Lee, Mann, Smith, McWilliams,, Sweeney & Ohlson, P.O. Box 2786, Chicago, IL, 60690-2786, US

(21) Appl. No.: 09/745,888

(22) Filed: Dec. 21, 2000

(51) Int. Cl. H04B 10/00; H04B 13/02; H04B 10/16

(52) U.S. Cl. 359/141; 359/179

(57) ABSTRACT

An underwater data transmission system has a cable for carrying an optical signal to carry data, and a string of repeaters spaced apart along the cable, for transmitting the data along the cable, and is upgradeable in mid life by including an upgradeable repeater. The system may have a switchable loop to enable upgrading by adding an additional repeater to the loop and switching the loop into the data path. This enables the data capacity to be increased without needing to lift all the repeaters to the surface. This can enable the huge deployment costs of underwater systems to support several generations of advances in optical transmission systems. It makes more use of the usual twenty year design life of the physical infrastructure.

### RELATED APPLICATIONS

This application relates to co-pending U.S. patent application No.______ (Nortel Networks reference 13621) entitled TELECOMMUNICATIONS SYSTEM POWER SUPPLY, filed on the same date, and hereby incorporated by reference.

### FIELD OF THE INVENTION

The invention relates to underwater data transmission systems, to upgradeable repeaters for such systems, to apparatus for upgrading such systems, to upgraded systems, to data signals carried by such systems, to methods of transmitting data, and to methods of upgrading underwater data transmission systems.

### BACKGROUND TO THE INVENTION

It is known to provide data transmission systems between land sites separated by water. Fibre optic data transmission systems are used. For spans beyond several hundred kilometers, repeaters are required at intervals along the cable. These repeaters may take the form of optical amplifiers, for increasing the optical signal strength, without re-timing or reshaping. After anything from 1000-10000 kilometers, the timing and shape of the optical signal pulses deteriorates, and signal regeneration is required. This currently involves conversion to electrical domain, though optical regenerators are being actively developed.

Power for the underwater repeaters is supplied along the same cable as is used for the optical fibers. This is a crucial difference between land based optical data transmission systems, and underwater systems. While capacity of land based systems has grown rapidly, as data rates have increased up to 10 G bits per second and the number of channels multiplexed together on the same fibre, has increased in to the hundreds, underwater systems have not matched this growth. The two primary reasons are the limitation in the amount of power which can be fed to underwater repeaters, and the extremely high reliability requirements for such underwater equipment. The reliability is required because underwater equipment is so inaccessible for maintenance or repair, once installed.

In particular, optical pumps for optical amplifiers may be responsible for much of the power consumption and these components may be amongst the least reliable, depending on the pump power level and other factors. It is known to provide for remote control of the pump power level, and to provide multiple pumps, independently controlled to share the load. Consequently, if one pump fails, the others can have their power outputs increased, to compensate. This may avoid the enormous cost of lifting a repeater from the seabed to repair it.

The enormous cost of lifting repeaters from the seabed means it is not economic to replace the repeaters to exploit advances in repeater technology. Instead a complete new cable would be laid. It is also known from electronic letters Volume 34, No. 1, Jan. 8, 1998, pages 100-111 “WDM Submarine Cable System designed for capacity upgrade” by Otani et al, to provide for upgrade from single channel to WDM transmission in a submarine system by changing the terminals without replacing the repeaters. In this system the transmitter and receiver terminals on land at each end of the underwater system start off as relatively inexpensive single channel equipment, and are later upgraded to more expensive WDM equipment. To achieve this, the repeaters, particularly their power supply and optical pumps, need to be designed for higher output power than would normally be the case for a single channel transmission.

### SUMMARY OF THE INVENTION

It is an object of the invention to provide improved systems and methods. According to the invention there is provided an underwater data transmission system having a cable for carrying an optical signal to carry data, and a string of repeaters spaced apart along the cable, for transmitting the data along the cable, at least one of the repeaters being an upgradeable repeater, to enable the system to be upgraded without needing to lift all the repeaters to the surface.

The inventors recognised that it is not necessary to be able to upgrade all the optical repeaters uniformly. Significant upgrades in performance, to give increased data capacity for example, can be achieved by enhancing only selected ones of the optical repeaters in the string. The inventors recognised that such systems can be designed to be upgraded more cost effectively than before. This can enable the huge deployment costs of underwater systems to support several generations of advances in optical transmission system.

This enables the useful life to be extended, and so increase the return on the high initial investment. It also makes use of the fact that the design life of the cable and infrastructure is currently typically over twenty years. The advances in data capacity as technology develops are likely to be so great within this timescale that several generations of advances or several upgrades could be carried out. Without such upgrades, this twenty year design life is wasted if the data capacity advances make the system obsolete long before the end of the twenty years.

A preferred feature added to the above aspect involves the upgradeable repeaters being spaced apart by others of the repeaters, along the string of repeaters. This enables the benefit of the upgrade of the selected repeaters to be spread evenly along the string, which reduces the number of consecutive non-upgraded repeaters along the string. Reducing this number can reduce the losses or degradations in signal, which otherwise accumulate. This enables the data capacity to be increased with fewer upgraded repeaters.

Another preferred feature involves the upgradeable repeater having an arrangement for making it more accessible for upgrading, than others of the repeaters. This enables the costs of upgrading the selected upgradeable repeaters to be reduced, without necessarily adding to the cost of all the repeaters.

Another preferred feature sees the arrangement of the upgradeable repeater having a loop branching off the cable, and switching apparatus for setting the path for the data to bypass the loop and continue along the cable or to pass around the loop. This is more accessible for upgrading since an additional repeater or other upgrade equipment can be installed into the loop while data continues to be transmitted, bypassing the loop. Then the data path can be switched onto the loop and make use of the upgrade equipment with little or no disruption to traffic and without needing to cut the cable.

Another preferred feature has the loop being arranged to return to the same upgradeable repeater, and the switching apparatus being further arranged to couple the loop to the cable to enable data from the loop to continue along the cable. Having the loop return to the cable at the same repeater is convenient to enable the number of repeaters and the length of the loop to be reduced, to reduce costs and maintain reliability.

Preferably, the switching apparatus has a four port optical switch, an input port and an output port of the optical switch being coupled in series with the cable, and another input port and another output port being coupled to respective ends of the loop. This is a convenient way of implementing the switching arrangement to keep the number of components low, to reduce costs and maintain high reliability.

Another preferred feature involves the loop being sufficiently long to enable it to be lifted to the surface after installation underwater, without needing to cut the cable. This can enable the insertion of the upgrade equipment to be carried out when the loop is lifted to the surface, and achieve reduced costs and maintain reliability by avoiding the need to lift, cut and resplice the cable.

Another preferred feature sees the upgradeable repeater having a casing containing repeater circuitry, the arrangement comprising an access port in the casing to allow the repeater circuitry to be accessed for upgrading, without detaching the repeater from the cable. This may enable one of the more delicate and difficult tasks, of detaching and reattaching the cable including fragile optical fibers, to be avoided. Thus costs can be reduced and reliability maintained, and it becomes easier to do the upgrade underwater and avoid lifting the repeater.

Another preferred feature involves the repeater casing having the cable attached at one end of the casing only, and the access port at an opposite end of the casing. This is a convenient way of enabling the repeater circuitry to be accessed without having to detach the cable.

Preferably, the arrangement comprises a length of slack in the cable adjacent the upgradeable repeater when installed underwater, the slack being of sufficient length to enable the upgradeable repeater to be lifted to the surface without needing to cut the cable. This can enable the cost of the upgrade to be reduced, and reliability to be maintained, by avoiding the need to cut, lift, and resplice the cable.

Preferably, the system has a power supply route along the cable for powering the repeaters, the upgradeable repeater being allocated more power than others of the repeaters. As the power allocation is sometimes a limiting factor in system design, later upgrading may be more difficult unless some additional margin is provided for the selected repeaters at the outset.

Preferably the upgradeable repeater has a branch for a power supply cable. This may enable more power to be supplied at upgrade time, from another power cable. This is particularly useful where power supply along the data cable is limited by the weight of copper and insulation needed, making it hard to supply more power along the data cable. The extra power could be used either by upgraded repeaters, or by existing repeaters, or both. Where the upgrade involves supplying additional power to existing repeaters, this can enable additional data capacity either by allowing more channels to be amplified, or by enabling a higher data rate on existing channels, or both.

Another preferred feature sees the branch having a tail long enough to be lifted to the surface without lifting the upgradeable repeater. This enables more power to be provided by connecting a power cable to the branch at upgrade time, without disturbing the repeater or having to cut and resplice the data cable.

In another preferred feature, all the repeaters have a branch for a power supply cable. This enables more power to be supplied at any location, thus avoiding the need to predetermine at installation which of the repeaters are upgradeable.

Another aspect of the invention provides an underwater data transmission system having a cable for carrying the data, and a string of repeaters spaced apart along the cable, for transmitting the data along the cable, the system being upgradeable without needing to lift all the repeaters to the surface, by providing additional fibers in the cable, initially unused, at least some of the repeaters having a branch for a loop or for a power supply cable, to enable the system to be upgraded later to bring the additional fibers into use. This is particularly useful where capacity is limited at installation by the amount of power which can be supplied to the repeaters, or by the number of amplifiers which can be accommodated.

Another aspect of the invention provides an upgradeable repeater suitable for use in the system set out above, and having a loop branching off the cable, and switching apparatus for setting the path for the data to bypass the loop and continue along the cable or to pass around the loop.

Another aspect of the invention provides an upgradeable repeater suitable for use in the system set out above, and having two couplings for the cable of the system, and a branch for a power supply cable.

Another aspect of the invention provides upgrade apparatus suitable for upgrading the system set out above, the upgrade apparatus having apparatus for upgrading the terminal equipment, and repeater apparatus for upgrading the upgradeable repeater.

A preferred feature for adding to the above aspect involves the repeater apparatus providing increased data transmission capacity by upgrading an optical performance characteristic of the selected repeater.

Another preferred feature for a system having many channels wavelength multiplexed together, involves the upgrade apparatus providing transmission of an increased number of the channels.

In another preferred feature, the repeater apparatus is arranged to provide dynamic gain control of the channels.

In another preferred addition, the upgrade apparatus is arranged to provide an increase in optical power output of some or all of the string of repeaters, the repeater apparatus providing dynamic compensation of optical signal degradation in the system when upgraded.

Other preferred features involve the compensation being for at least one of chromatic dispersion or polarisation mode dispersion, the repeater apparatus having apparatus for optical regeneration of an optical data signal, or the apparatus for optical regeneration having a saturable absorber, a non linear optical loop mirror, or apparatus for synchronous remodulation, or combinations of these.

Another preferred feature involves the repeater apparatus providing electrical regeneration of an optical data signal, or being arranged to provide upgraded forward error correction.

Another aspect of the invention provides a method of upgrading an underwater transmission system, the system comprising a cable, terminal equipment and a string of underwater repeaters along the cable, the method comprising the steps of upgrading the terminal equipment and selected ones of the repeaters, without lifting others of the repeaters, to provide increased data transmission capacity.

Another aspect of the invention provides a method of upgrading the underwater data transmission system set out above by coupling the power supply cable to the branch to supply more power to the repeater or repeaters, or by coupling a repeater into the loop carried by the branch.

Another aspect of the invention provides an upgraded underwater transmission system having a cable for carrying an optical signal to carry data, and a string of repeaters spaced apart along the cable, for transmitting the data along the cable, and at least one loop carrying the data to an additional repeater.

Another aspect of the invention provides a data signal transmitted by the upgraded system set out above.

Any of the preferred features may be combined with any of the aspects of the invention, as would be apparent to a skilled person. Other advantages will be apparent to a skilled person, particularly in view of other prior art of which the inventors are not aware.

### BRIEF DESCRIPTION OF THE DRAWINGS

FIG. 1 shows a prior art underwater data transmission system;

FIG. 2 shows an embodiment of the invention including upgraded terminals and an upgraded repeater;

FIG. 3 shows steps in upgrading a system;

FIG. 4 shows an upgraded terminal for use in the upgraded system of FIG. 2;

FIG. 5 shows a prior art repeater for use in the systems of FIGS. 1 or 2;

FIG. 6 shows an upgraded repeater without signal regeneration, for use in the system of FIG. 2;

FIG. 7 shows an upgraded repeater with optical regeneration, for use in the system of FIG. 2;

FIG. 8 shows an upgraded repeater with electrical regeneration, for use in the system of FIG. 2;

FIG. 9 shows another embodiment of the invention, an underwater data transmission system designed to be upgradeable;

FIG. 10 shows another embodiment of the invention, an upgraded system with added power supply;

FIG. 11 shows another embodiment of the invention, a repeater designed for upgrading by adding power supply, suitable for the system of FIG. 9 or FIG. 10;

FIG. 12 shows another embodiment of the invention, an upgradeable repeater with access to the repeater circuitry without having to detach the cables; and

FIGS. 13 and 14 show another embodiment of the invention, an upgradeable repeater having a loop for adding a further repeater.

### DETAILED DESCRIPTION

To show how the invention may be put into effect, by way of example, embodiments will be described in more detail.

FIG. 1

FIG. 1 shows a prior art underwater data transmission system, having a cable 10 extending between terminals 30. A string of repeaters 20 along the cable, enables the data to be transmitted between the terminals in both directions. Typically the repeaters are powered from the terminals, through a power conductor in the cable (not shown).

In the context of the invention, the term “repeater” is intended to encompass one or more optical amplifiers, single direction or bidirectional optical amplification, distributed optical amplification, such as Raman amplification, where is the amplifying action may take place along the transmission fibre, not only within the repeater housing, and any type of signal regeneration. Typically signal regeneration is carried out after 10-20 spans of optical amplification, though longer distances between regeneration are desirable, and are being developed. The signal regeneration may involve separating a WDM signal into constituent wavelengths, and regenerating each wavelength, or each channel, individually. The regeneration may involve reshaping, retiming, and amplifying to increase the amplitude, singly or any combination of these. It may involve conversion of an optical signal into electrical domain, or may be carried out in part or in whole in the optical domain. Repeaters may include other equipment such as monitoring equipment, switches, and conceivably muxers and demuxers for example.

Typically the repeaters are spaced at intervals of 50 to 100 kilometers. More details of the repeater are described below with reference to FIG. 5.

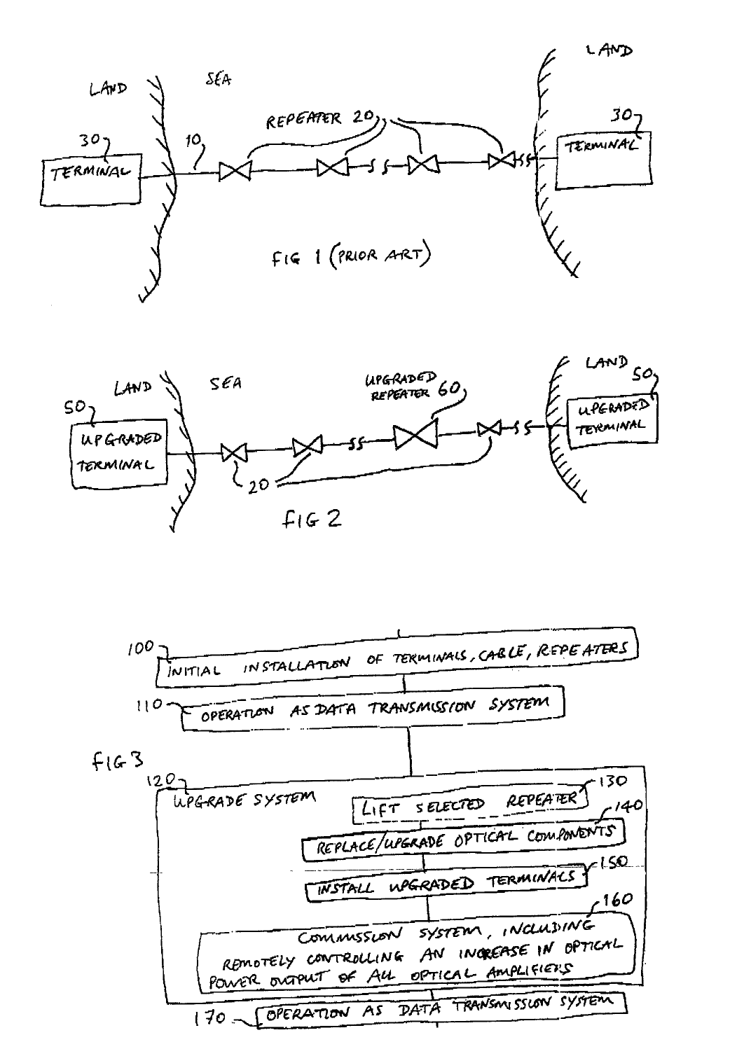

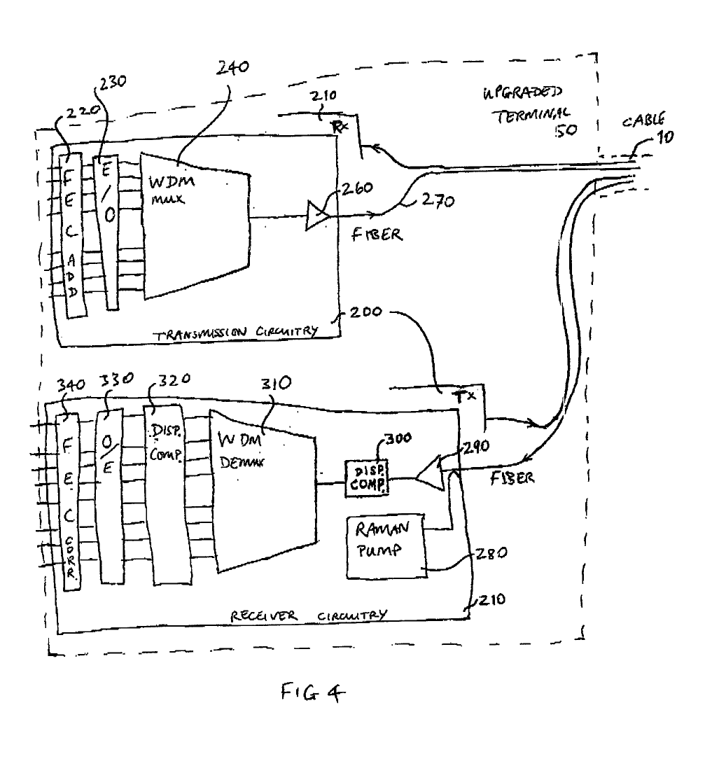

FIG. 2

FIG. 2 shows an embodiment of the invention in which the system of FIG. 1 has been upgraded. The terminals 50 are now upgraded terminals, and one of the repeaters 60 is now an upgraded repeater. In a typical transoceanic system, there would be tens or hundreds of repeaters. More than one upgraded repeater would be required. Typically every tenth repeater might need to be upgraded. The proportion of repeaters to be upgraded will depend on the cost of upgrading them, and the desired performance. As will be described below, various levels of upgrade are conceivable. For upgrades which achieve greater performance improvement, the spacing between upgraded repeaters can be larger.

FIG. 3

FIG. 3 shows principal steps involved in upgrading an underwater data transmission system, according to an embodiment of the invention. At step 100 the system including terminals, cable, and repeaters, is installed initially. At 110 it is operated in its initial configuration, as a data transmission system. At step 120 the system is upgraded. The upgrade includes at step 130 lifting selected ones of the repeaters from the seabed. This may involve a ship, which drags for the cable closer to the repeater. When hooked, the cable is cut, and the end closer to the repeater is lifted, and pulled onto the ship until the repeater is on the ship.

At step 140, the optical components of the repeater, and perhaps other components, are replaced or upgraded. Alternatively, a completely new repeater housing is spliced onto the cable instead of the old repeater housing.

To reconnect the cable, typically, an additional patching section of cable is added to the repeater, at least as long as the depth of water, then the ship can be moved back over the other severed end left on the seabed, laying the new repeater as it goes. This other severed end can then be lifted from the seabed, and on the ship it can be spliced to the end of the patch cable, and the spliced cable can be lowered to the seabed again.

At step 150 the upgraded terminals on land can be installed. This may involve replacing cabinets of equipment, or replacing cards in a rack or simply adding more cards, depending on the system and the type of upgrade.

At step 160, the upgraded system is commissioned, including the step of remotely controlling an increase in optical power output of the old repeaters 20. As will be described in more detail with reference to FIG. 5 below, normally optical amplifiers in underwater repeaters are provided with at least two pump sources, with the power for the pump sources being controllable remotely from the land based terminals. This is because the pumps are one of the least reliable parts, and therefore in the event of failure of a pump, there is typically provisioned to remotely control an increase in the output power of the remaining pump, to compensate.

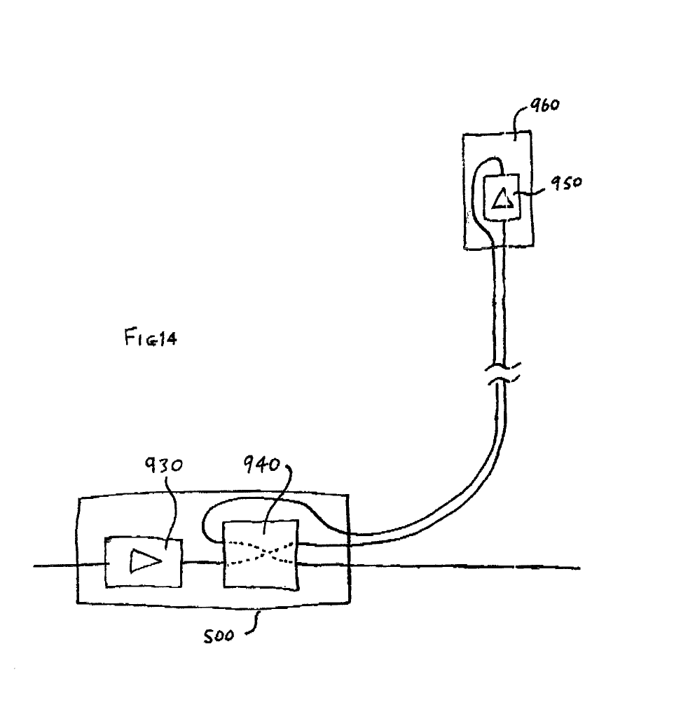

Finally, at step 170, the data transmission can be operated in its upgraded form, to transmit data with increased data capacity. This increasing capacity can be in the form of increased bit rate, or an increased number of wavelength multiplexed channels, or both. Also, if the system was originally provided with additional unused fibers, with unused amplifiers in the repeaters, then the increased data capacity can be provided by increasing the number of operational fibers. This typically requires more power supply to each of the repeaters, and one way of upgrading one or more of the repeaters to achieve this, is described below with reference to FIGS. 9, 10 and 11. A way of adding more repeaters is shown below with reference to FIGS. 13 and 14, and this might be used to enable additional unused fibers to be brought into use.

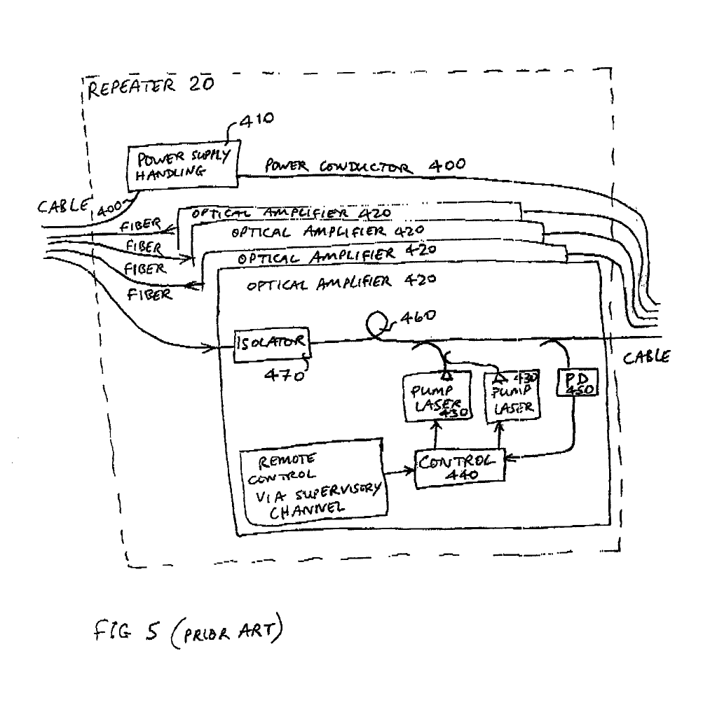

FIG. 4

FIG. 4 shows an example of an upgraded terminal for use in the system shown in FIG. 2. Two pairs of fibers are shown, one of each pair being coupled to transmission circuitry 200, the other fibre of each pair being coupled to receiver circuitry 210. Although existing underwater systems tend to be limited to 4 or 5 pairs of fibers, by power supply limitations, future systems are likely to have tens of pairs of fibers, as demand for data capacity increases, and as power supply limitations are overcome. Two pairs of fibers only are illustrated in FIG. 4 only for the sake of clarity.

Also not shown for the sake of clarity, are the power supply arrangements and the power conductor which extends along the cable 10 to supply power to the repeaters. The upgraded terminal takes advantage of improved optical components to enable more wavelengths to be multiplexed together, and more bits to be transmitted in each wavelength. Increasing the number of wavelengths can involve reducing the spacing between wavelengths, and broadening the range of bandwidths transmitted. To achieve this while using the existing cable, and most of the existing repeaters, requires measures to be taken both in the upgraded repeaters and the upgraded terminals. A selection of some or all of the measures described, can be made, depending on the usual considerations of system performance versus costs, and depending on which technologies have developed in to commercially available components at the time of a future upgrade. Hence FIG. 4 represents only an example of a configuration which might be a candidate for a future upgrade.

The transmission circuitry includes FEC (Forward Error Correction) Circuitry 220 acting on each of the input channels. The input channels may be OC48 or OC192 signals for example. The FEC circuitry calculates a number of error correction bits for a given number of bits of a given channel, and adds the error correction bits as overhead to that channel, or to a separate overhead channel. Many algorithms are known for achieving this, and new algorithms may be developed to operate faster, or with less overhead, or improved error correction performance. Conventionally, such circuitry is implemented in an application specific integrated circuit (ASIC) though software implementations may be conceivable in the future.

Conversion from electronic digital signals to optical signals takes place at stage 230. This may be a straight forward binary amplitude modulation arrangement, or more complex multilevel amplitude modulation, or combinations of amplitude and phase modulation. The output of the electrical to optical conversion stage 230 will be a number of signals of different optical wavelengths, each with data from one or more channels modulated on to them. The different wavelengths are multiplexed together at stage 240. This may take place in one or more than one stage, using established principles and techniques. Finally, an optical amplifier 260 provides the increased optical power necessary to transmit the broadband optical signal down the fibre 270 which extends along the cable 10, along with the other fibers.

On the receiving side, the receiver circuitry 210 includes a Raman pump 280 for providing optical amplification distributed along the transmission fibre. An optical preamplifier 290 precedes a broadband dispersion compensation unit 300 to achieve coarse dispersion compensation. This is followed by WDM demultiplexing stages which correspond to the multiplexing stages in the transmission circuitry. Before conversion to electrical domain, there may be optical compensation stages such as narrowband dispersion compensation 320. Finer compensation may be achieved by carrying it out on all or some of the individual channels, though at the expense of needing many more components. This compensation may be arranged to be dynamically adjustable for each channel. Various ways to achieve adjustable dispersion compensation have been published, and so need not be described here in more detail. Likewise PMD (Polarisation Mode Distortion) may also be compensated for (not illustrated), and again various methods have been published, as would be known to a skilled person, and so they need not be described here in more detail.

The conversion from optical signals to electrical signals at stage 330, will correspond to the conversion carried out in the transmission circuitry. The electrical digital signals will then be fed to FEC correction circuitry 340 for performing the error correction based on the FEC overhead.

FIG. 5

FIG. 5 shows a prior art underwater repeater 20. The repeater is shown coupled to the cable 10 which includes a number of pairs of fibers (two pair only are shown, for the sake of clarity), and a power conductor 400. The repeater includes power supply handling circuitry 410, for switching and conditioning power from the power conductor, to the optical amplifiers 420. Each of the optical amplifiers 420 includes a pump laser 430 (normally two or more of these are provided for redundancy), control circuitry 440, and optical feedback of output power level, via a photodiode 450. The rare earth doped amplifying fibre 460 in the optical path, is counter pumped by the pump lasers, with an isolator 470 provided to stop the pump wavelengths from being transmitted further.

Normally, separate optical amplifiers are provided for each direction of data transmission, and normally there is one per fibre. Some remote control of the power of the pump lasers 430 is provided. Control signals can be transmitted to the repeaters over a supervisory channel either on the same fibre, or on another fibre. A number of methods of superimposing such low frequency data signals have been published, and so would be well known to a skilled person, and need not be described here in detail. Normally, this enables remote detection of failure of one of the pump lasers. Provided the pump lasers were running at less than half their possible power output, then the remaining good pump laser can be controlled to increase its power output sufficiently to compensate for the failed pump laser.

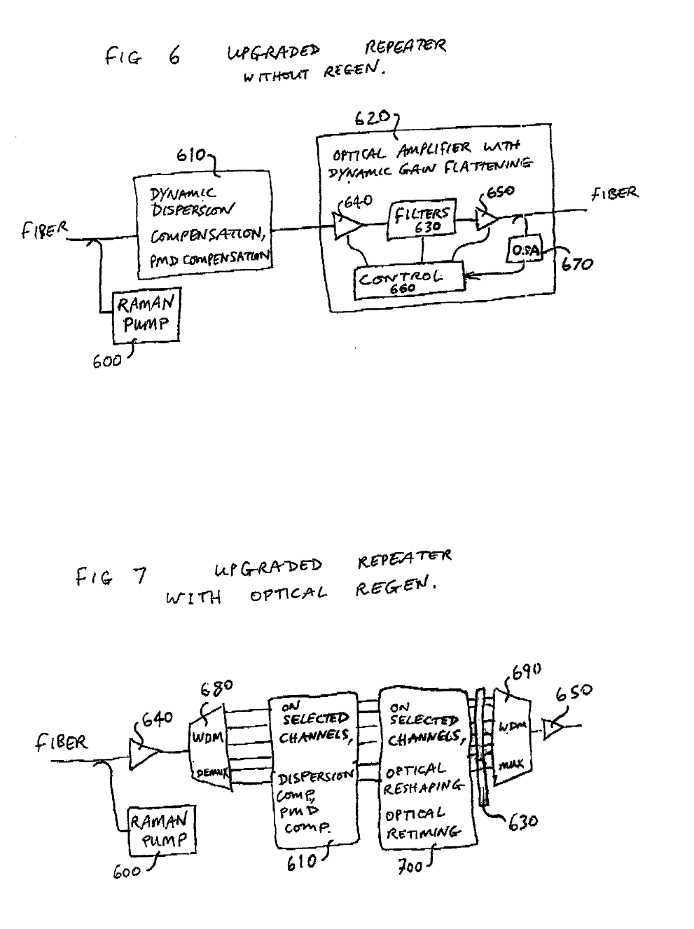

FIG. 6

FIGS. 6, 7 and 8 show examples of how the upgraded repeater 60 shown in FIG. 2 may be implemented. In each case, again a selection of the various upgrade features shown, or variations on them, may be implemented as desired. In each case, the result of increasing the data capacity of the transmission system, for example by higher bit rates, and more wavelengths, is that it is harder at the receiver to distinguish the data from the noise. Accordingly, higher optical signal powers will be necessary, which will result in more non-linear distortion, and more gain tilt in the non-upgraded optical amplifiers. The upgraded repeaters can clean up the optical signal sufficiently using various techniques.

FIG. 6 shows a Raman pump 600, for counter pumping the transmission fibre, to achieve distributed amplification. In the optical path dynamic dispersion compensation and PMD compensation may be provided in unit 610. Various ways of implementing these types of compensation have been published, and would be known to a skilled person, and so are not described here in more detail. Such dispersion compensation may be provided separately for each wavelength, in which case the unit will include wavelength demultiplexing and remultiplexing elements. Alternatively, the dispersion compensation could be broadband. Dispersion compensation and PMD compensation tend to be significant at bits rates above 10 G bits per second.

The optical amplifier assembly 620 is provided with dynamic gain flattening. Gain tilt tends to build up along a string of optical amplifiers. It will be accentuated if the amplifiers are amplifying more wavelengths with higher output powers than the original design specification. This will lead to more likelihood of bit errors through noise in the channels with least power, and through non-linearities induced in the channels with most power. It is therefore important to correct it, and it can be corrected by dynamic gain flattening at the upgraded repeaters inserted at intervals along the string of repeaters. The gain flattening can be controlled to compensate for tilt in preceding optical amplifiers up-stream in the optical path. It can also be controlled to effectively precompensate for gain tilt in succeeding optical amplifiers down-stream.

In a preferred arrangement, as illustrated, filters 630 are provided for selective attenuation of particular wavelengths. The filters are located in between two optical amplifiers, a preamplifier 640, and a postamplifier 650. Control circuitry 660 uses feedback from a device such as an Optical Spectrum Analyser (OSA) 670 which detects output powers at various wavelengths. Further input to the control unit 660 may come from remote repeaters via a supervisory channel (not shown, for the sake of clarity). Other arrangements for achieving dynamic gain flattening are possible, various are illustrated in published patent application EP 0 794 599, for example.

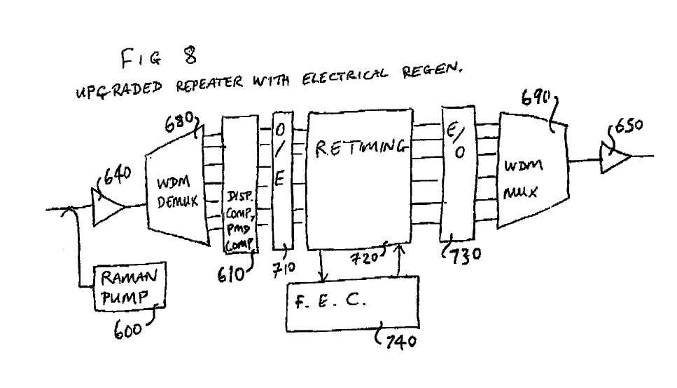

FIG. 7

FIG. 7 shows another example of how the repeater may be upgraded, this time with optical regeneration. Optical regeneration includes any regeneration of the optical signal without conversion of the data into the electrical domain. Such regeneration encompasses either retiming alone, reshaping alone, or both together. In FIG. 7, the techniques of FIG. 6 are used, and in addition optical reshaping and optical retiming are carried out, to compensate for distortion introduced by non-linearities and phase errors from various sources. If the optical reshaping and optical retiming is carried out on individual wavelengths, wavelength demultiplexing and remultiplexing is provided. The level of multiplexing and demultiplexing required can be reduced by using broadband regeneration techniques on groups of wavelengths. It is convenient to provide the dispersion compensation, PMD compensation, and gain flattening attenuation on the demultiplexed signals.

Various techniques are available for the optical regeneration. For re-timing, synchronous remodulation can be used, which involves extracting a clock signal from the optical signal input and applying it to an optical modulator to remodulate the optical input. For re-shaping, a saturable absorber such as a semiconductor element can be used. Non linear optical loop mirrors can also be used. An example is a dispersion imbalanced loop mirror (DILM) described in various publications including at least one from Bristol University in the UK. These are examples only, and others are possible. Numerous publications are available on these topics, as would be known to a skilled person and the reader is referred to such publications for more details.

Features shown already in FIGS. 6 are given the same referenced numeral in FIG. 7 as appropriate. WDM demultiplexer 680 follows the preamplifier 640. Optionally, a broadband dispersion compensator (not shown) may be added before WDM demultiplexer 680.

Optical reshaping and retiming block 700 is preferably sandwiched between the dispersion compensation and PMD compensation block 610, and the gain flattening filters 630. The dispersion compensation and/or PMD compensation may be carried out on all or only selected ones of the channels, to reduce the number of components. For example it could be carried out only on channels away from the “center” of the band of the broadband dispersion compensator, or on channels having lower power owing to gain tilt or being at the edge of the amplifier gain profile. Finally, WDM multiplexer 690 precedes the post-amplifier 650.

The optical reshaping and retiming may be implemented in a number of different ways. In particular, reshaping will be dependent on whether the optical signal is a binary, or multilevel signal. Various optical elements are available which give an output function which can convert a sinusoidal input into an output which is closer to a square wave. Such optical reshaping serves to open the “optical eye” to enable the receiver to correctly to distinguish the transmitted data. It is unlikely to be able to perform as well as electrical reshaping, but may be cheaper and/or more reliable.

Optical retiming involves introducing a phase shift to correction for phase errors, which can otherwise affect correct detection in the receiver, just as much as noise induced amplitude errors. This can be achieved in various ways. For example, a clock signal can be derived from the incoming optical signal, compared to a reference, and phase errors fed forward to a modulator which can be driven to achieve the phase shift. Again, various implementations can be conceived, based on publications which a skilled person would be aware of.

Again, the optical reshaping and retiming may be carried out on all channels, or only on selected channels to reduce the component count, and therefore the cost and complexity. If broadband optical regeneration devices are developed, then the demux and mux elements can perhaps be avoided, and the component count reduced more dramatically for future upgrades.

FIG. 8

FIG. 8 shows a third example of how the upgraded repeater may be implemented, this time with electrical regeneration. This should enable even more performance improvement than the optical regeneration of FIG. 7, though at increased expense. Again, features shown in FIGS. 6 and 7 have been given the reference numerals. In comparison with FIG. 7, in place of the optical reshaping and optical retiming unit 700, and the gain filters 630, there is provided optical to electrical conversion (O/E) 710, electrical retiming, 720, and corresponding electrical to optical conversion (E/O), 730. Optionally, in the electrical domain, error correction is carried out to using the FEC overhead, and new FEC overhead is inserted for down-stream transmission, using unit 740.

There would be no need for dynamic gain flattening, because the gain at each wavelength would be set by the E/O conversion unit 730. The additional performance comes at considerable additional expense, in view of the high speed electrical circuitry required, and the optical sources required for each of the wavelengths. This upgradable repeater is also likely to require considerably more power. However, the improved performance may mean fewer of these upgraded repeaters would be needed.

FIG. 9

FIG. 9 shows some measures which may be taken at installation to make the system easier to upgrade. Some or all of the underwater repeaters 800 are provided with a tail branched off the repeater (or off the cable near the repeater). The tail 810 is unconnected when laid initially, and is laid away from the main cable. It is there to enable additional power to be coupled in to the individual repeater, or in to the power network supplying the entire transmission system. By laying the tail 810 away from the main cable, it can be dragged for and lifted to the surface without disturbing the corresponding repeater, or the main cable. At the surface, it can be spliced to a separate power supply cable which can be laid later, at the time of upgrading the system.

This can avoid the need to provide extra power carrying capacity in the main cable from the outset. As the weight and cost of the cable may depend heavily on the amount of copper used, and the amount of insulation required against the high voltage power supply along the cable, it may not be cost effective to provide much margin for upgrading.

Another feature for making upgrading easier is the cable slack shown at either side of one of the repeaters, 820. This may enable the repeater to be lifted without necessarily cutting the cable. Another technique, not illustrated, is to make the repeater spacing reduced, to give more optical margin, than would normally be allowed. This enables more scope for the future upgrade, at the cost of additional repeaters.

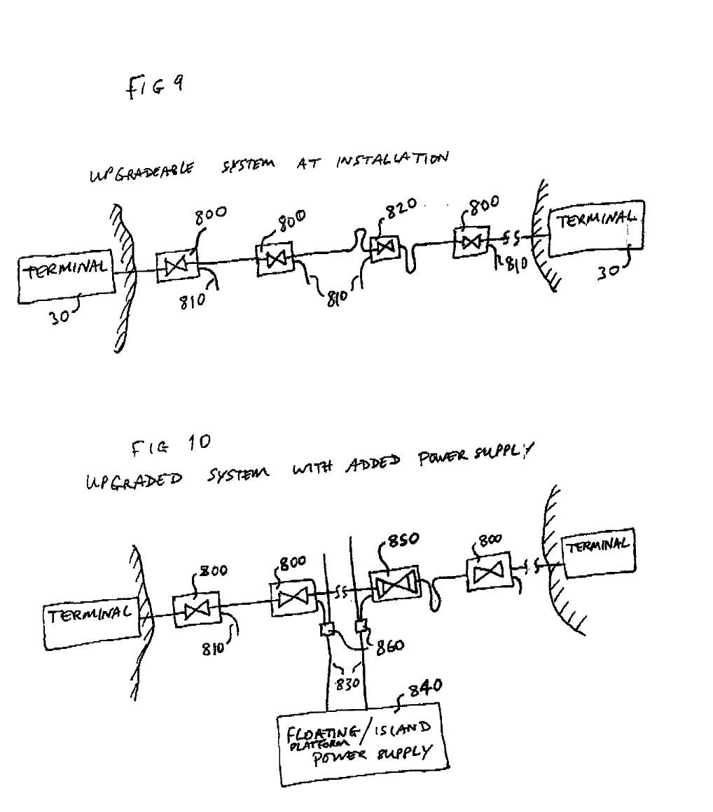

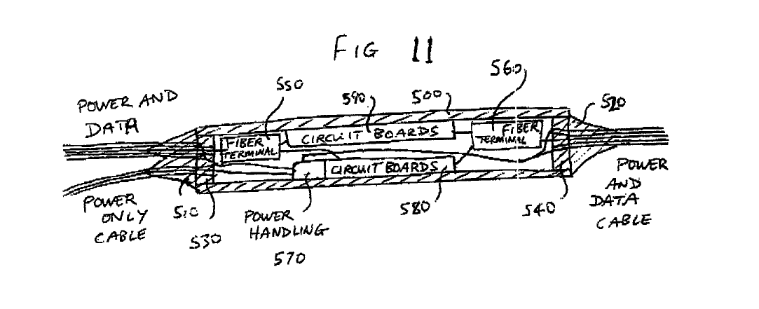

FIG. 10

As power supply may be a limiting factor in the ability to upgrade a system, FIG. 10 shows an upgraded system with later added power supply. One or more dedicated power supply cables 830 extend to cross the data carrying cable at some intermediate points in mid ocean. They could be supplied from a power source on a floating platform or an island 840, for example.

In the example illustrated, the tails 810 on two of the repeaters, have been lifted to be coupled to the closest power cables at junctions 860. This enables more power to be coupled in to the string of repeaters, without necessarily having to disturb the cable and repeaters to lift them to the surface. The junctions 860 may have power switching circuitry, or could be simply a junction of wires with no switching capability. The power cables 830 could extend transversely to the data cable, to reach other data cables (not shown).

As illustrated in FIG. 10, repeater 850 is an upgraded repeater, as described above, to provide improved optical performance, to enable increased data capacity. Depending on the required performance, there may be several upgraded repeaters spaced apart along the system, to clean up the optical signals, to compensate for the greater level of degradation caused by increased optical power, or reduced channel spacing, or other measures to increase the data capacity.

The upgraded system of FIG. 10 will have upgraded terminals arranged to provide more channels, and launch signals with higher optical powers, to achieve the increased data capacity. The upgraded terminals could be implemented as shown in FIG. 4 above. The upgraded repeater could be implemented as shown in any of FIGS. 6, 7 or 8, or in other ways, as would be apparent to a skilled person. An example of the physical structure of the repeater 800 or the upgraded repeater 850 will now be described.

FIG. 11, Structure of Repeater Designed for Adding Power Supply.

FIG. 11 shows in more detail how a repeater may be constructed with a power tail 810 for attaching to power cables 830, as described above. It shows in cross section in schematic form some of the important features of a typical underwater repeater having a three way casing. It can be used as the repeater 800 or the upgradeable repeater 820, 850, shown in FIG. 9 or 10. It has a cylindrical housing 500, strong enough to withstand high pressures underwater and traction or tension forces exerted on the cable while it is being laid or raised. One end has a power and data cable attached, the other end has two cables, one for power and data, the other for power only in this example. In a similar fashion, other configurations required for any of the repeaters shown in the preceding figures can be achieved.

Strain relief boots 510, 520 are provided at each end. The cables are provided with steel strength members terminated on strong end plugs 530, 540 securely attached to the housing. Apertures are provided in these end plugs to enable the power conductors and the data carrying optical fibers to be passed into the interior of the housing. This must be achieved without allowing any water ingress into the housing.

Inside the housing fibre terminals 550, 560 are provided to facilitate splicing of the optical fibers and to provide for longitudinal movement of the optical fibre to reduce tensile stress on the fibre as the cable is stressed.

The power conductors are fed to power handling circuit boards 570, where functions of switching, voltage step-down, AC to DC conversion and so on, may be carried out, depending on the power network configuration. Power grooming functions may also be needed here, such as surge suppression, voltage and current control and noise suppression, for example. Data handling functions are carried out on circuit boards 580, 590. Typically these are mounted on trays that can be slid longitudinally in and out of the housing. They are usually located so as to use the housing for thermal dissipation.

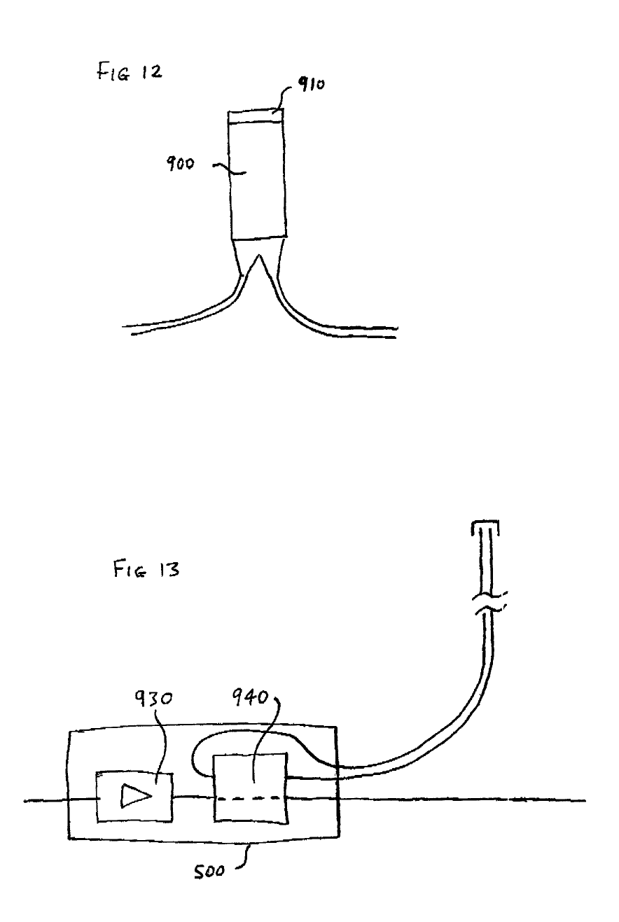

FIG. 12, Single Ended Repeater Housing to Facilitate Upgrading.

FIG. 12 shows an alternative arrangement for the upgradeable repeater, with an access port in the casing to allow the repeater circuitry to be accessed for upgrading without detaching the repeater from the cable. In contrast to the arrangement of FIG. 11 which requires the cable at one end to be detached to allow the circuit boards to be accessed, this is not necessary in the arrangement of FIG. 12. The casing 900 may be the conventional cylindrical casing, but instead of having cables attached to both ends, it has cables attached only to one end. At the other end is an access port 910. This may be implemented in the form of a strong metal cap removably fixed to the casing by a cylindrical thread or by discrete bolts.

This single ended arrangement may make it much easier to upgrade the repeater circuitry inside the cylindrical casing 900. Where the cost of lifting the repeater to upgrade it is prohibitive, it may be possible to perform the upgrade under water, especially if the delicate operation of detaching cables without damaging optical fibers, can be avoided.

Where the upgradeable repeater includes a power tail 810, there would be a third cable (not illustrated) coming out of the casing 900 of FIG. 12, at the same end as the other two cables. Other configurations to achieve the access of repeater circuitry without having to detach the cables, can be envisaged. For example, part of the cylindrical casing 500 shown in FIG. 11 could be made detachable, to gain access to the circuit boards. Alternatively, a T shaped casing could be used, by adding a transverse section of casing to the longitudinal casing shown in FIG. 11. The circuit boards could be contained entirely in the transverse section, accessible through an access port similar to that shown in FIG. 12. This arrangement would have the advantage that tensile forces along the cable would be taken along the longitudinal length of the casing rather than transverse to the casing as would occur in FIG. 12. In FIG. 12, some form of further stress relief (not shown) could be provided by coupling the two cables together beyond the stress relieving boots.

FIG. 13, Upgradeable Repeater with Switched Loop.

FIG. 13 shows a further type of upgradeable repeater having a branch for a loop to branch off the cable, and a switching apparatus 940 to select whether the data bypasses the loop, or travels around the loop. FIG. 13 shows an initial configuration before upgrading. FIG. 14 shows an upgraded configuration with a further repeater coupled in to the loop, and the switching apparatus set to couple that new repeater into the data path. By providing such a loop, the upgrade can be carried out without disturbing the original repeater. If the loop is long enough, and laid apart from the main data cable, the loop can be lifted and its open end brought to the surface, to attach the additional repeater 960. As shown in FIG. 14, the repeater 960, containing amplifier or regenerator 950 can be attached on to the end of the loop, using a single ended repeater casing (or a conventional two ended casing if preferred). Once the loop is completed, with the additional repeater 960 in the loop, the loop can be tested before it is returned to the sea bed.

The testing and subsequent normal operation of the loop can be carried out by the switching apparatus 940. The switching apparatus can be implemented either as a single 4 point switch, or as a pair of 3 point switches. The two ends of the loop arriving at the switching apparatus 940 are each coupled to different directions of the main data cable. In this way some or all of the data in the main cable is sent around the loop through the additional repeater 960 and back to the switching apparatus 940 to continue along the main data cable.

It is not essential that both ends of the loop are joined to the main cable at the same repeater housing, though it is usually cost effective to minimise the number of housings, and the number of components in the switching apparatus. Although illustrated in FIG. 14 for one direction of data transmission, clearly this is equally applicable to both directions of data transmission along the main data cable. Where there are multiple fibers in the data cable, typically separate switches are provided for each fibre. The loop may include a power conductor (not shown) to power the additional repeater 960. Alternatively, a power tail may be included running from the original repeater, or the additional repeater 960, to enable an additional separate power supply to be used for the additional repeater, as shown in FIG. 10 for example.

Although shown with the additional repeater 960 in series with an existing repeater 930, other layouts are conceivable. For example, the switching apparatus could be arranged to cause the existing repeater 930 to be bypassed when the loop is switched in to the data path. In another layout, the loop could be switched in to any one of a number of different fibers in the cable. Also, the loop could be switched in to a fiber with no existing repeater. This could enable the loop to be used to switch in repeaters to an unused fiber, to expand the data capacity.

Concluding Remarks

Above has been described an underwater data transmission system having a cable for carrying an optical signal to carry data, and a string of repeaters spaced apart along the cable, for transmitting the data along the cable, which is upgradeable in mid life by including an upgradeable repeater. The system may have a switchable loop to enable upgrading by adding an additional repeater to the loop and switching the loop into the data path. This enables the data capacity to be increased without needing to lift all the repeaters to the surface. This can enable the huge deployment costs of underwater systems to support several generations of advances in optical transmission systems. It makes more use of the usual twenty year design life of the physical infrastructure. Although described in relation to underwater systems, the invention is applicable and is intended to encompass any terrestrial systems for which the repeaters may be buried and thus correspondingly difficult or expensive to access. Other variations and improvements may be apparent to a skilled person within the scope of the claims.

1. An underwater data transmission system having a cable for carrying an optical signal to carry data, and a string of repeaters spaced apart along the cable, for transmitting the data along the cable, at least one of the repeaters being an upgradeable repeater, to enable the system to be upgraded without needing to lift all the repeaters to the surface.

2. The system of claim 1, the upgradeable repeaters being spaced apart by others of the repeaters, along the string of repeaters.

3. The system of claim 1, the upgradeable repeater having an arrangement for making it more accessible for upgrading, than others of the repeaters.

4. The system of claim 3, the arrangement of the upgradeable repeater having a loop branching off the cable, and switching apparatus for setting the path for the data to bypass the loop and continue along the cable or to pass around the loop.

5. The system of claim 4, the loop being arranged to return to the same upgradeable repeater, and the switching apparatus being further arranged to couple the loop to the cable to enable data from the loop to continue along the cable.

6. The system of claim 5, the switching apparatus having a four port optical switch, an input port and an output port of the optical switch being coupled in series with the cable, and another input port and another output port being coupled to respective ends of the loop.

7. The system of claim 4, the loop being sufficiently long to enable it to be lifted to the surface after installation underwater, without needing to cut the cable.

8. The system of claim 3, the upgradeable repeater having a casing containing repeater circuitry, the arrangement comprising an access port in the casing to allow the repeater circuitry to be accessed for upgrading, without detaching the repeater from the cable.

9. The system of claim 8, the repeater casing having the cable attached at one end of the casing only, and the access port at an opposite end of the casing.

10. The system of claim 3, the arrangement comprising a length of slack in the cable adjacent the upgradeable repeater when installed underwater, the slack being of sufficient length to enable the upgradeable repeater to be lifted to the surface without needing to cut the cable.

11. The system of claim 1, having a power supply route along the cable for powering the repeaters, the upgradeable repeater being allocated more power than others of the repeaters.

12. The system of claim 1, the upgradeable repeater having a branch for a power supply cable.

13. The system of claim 12, the branch having a tail long enough to be lifted to the surface without lifting the upgradeable repeater.

14. The system of claim 11, all the repeaters having a branch for a power supply cable.

15. An underwater data transmission system having a cable for carrying the data, and a string of repeaters spaced apart along the cable, for transmitting the data along the cable, the system being upgradeable without needing to lift all the repeaters to the surface, by providing additional fibers in the cable, initially unused, at least some of the repeaters having a branch for a loop or for a power supply cable, to enable the system to be upgraded later to bring the additional fibers into use.

16. An upgradeable repeater suitable for use in the system of claim 1, and having a loop branching off the cable, and switching apparatus for setting the path for the data to bypass the loop and continue along the cable or to pass around the loop.

17. An upgradeable repeater suitable for use in the system of claim 1 and having two couplings for the cable of the system, and a branch for a power supply cable.

18. Upgrade apparatus suitable for upgrading the system of claim 1 comprising apparatus for upgrading the terminal equipment, and repeater apparatus for upgrading the upgradeable repeater.

19. The upgrade apparatus of claim 18, the repeater apparatus providing increased data transmission capacity by upgrading an optical performance characteristic of the selected repeater.

20. The upgrade apparatus of claim 18, for a system having many channels wavelength multiplexed together, the upgrade apparatus providing transmission of an increased number of the channels.

21. The upgrade apparatus of claim 20, the repeater apparatus arranged to provide dynamic gain control of the channels.

22. The upgrade apparatus of claim 18, arranged to provide an increase in optical power output of some or all of the string of repeaters, the repeater apparatus providing dynamic compensation of optical signal degradation in the system when upgraded.

23. The upgrade apparatus of claim 22, the compensation being for at least one of chromatic dispersion or polarisation mode distortion.

24. The upgrade apparatus of claim 18, the repeater apparatus having apparatus for optical regeneration of an optical data signal.

25. The upgrade apparatus of claim 24, the apparatus for optical regeneration having a saturable absorber.

26. The upgrade apparatus of claim 24, the apparatus for optical regeneration having a non linear optical loop mirror.

27. The upgrade apparatus of claim 24, the apparatus for optical regeneration having apparatus for synchronous remodulation.

28. The upgrade apparatus of claim 18, the repeater apparatus providing electrical regeneration of an optical data signal.

29. The upgrade apparatus of claim 18, arranged to provide upgraded forward error correction.

30. A method of upgrading an underwater transmission system, the system comprising a cable, terminal equipment and a string of underwater repeaters along the cable, the method comprising the steps of upgrading the terminal equipment and selected ones of the repeaters, without lifting others of the repeaters, to provide increased data transmission capacity.

31. A method of upgrading the underwater data transmission system of claim 15 by coupling the power supply cable to the branch to supply more power to the repeater or repeaters, or by coupling a repeater into the loop carried by the branch.

32. An upgraded underwater transmission system having a cable for carrying an optical signal to carry data, and a string of repeaters spaced apart along the cable, for transmitting the data along the cable, and at least one loop carrying the data to an additional repeater.

33. A data signal transmitted by the upgraded system of claim 32.
